(19) United States
(12) Patent Application Publication
(10) Pub. No.: US 2018/0357969 A1
(43) Pub. Date: Dec. 13, 2018

(54) METHOD OF ELIMINATING RIPPLES CAUSED BY LVDS SPREAD SPECTRUM

(71) Applicant: Shenzhen China Star Optoelectronics Technology Co., Ltd., Shenzhen, Guangdong (CN)

(72) Inventors: Penggang CHANG, Shenzhen, Guangdong (CN); Nianmao WANG, Shenzhen, Guangdong (CN); Dongsheng GUO, Shenzhen, Guangdong (CN)

(73) Assignee: Shenzhen China Star Optoelectronics Technology Co., Ltd., Shenzhen, Guangdong (CN)

(21) Appl. No.: 15/129,789

(22) PCT Filed: Jul. 12, 2016
(86) PCT No.: PCT/CN2016/089794

§ 371 Date: Sep. 27, 2016

(30) Foreign Application Priority Data
May 30, 2016 (CN) 201610371132.4

(51) Int. Cl. G09G 3/36

(52) U.S. Cl. CPC G09G 3/3611; G09G 2330/06; G09G 2310/08; G09G 2320/06

(57) ABSTRACT

The disclosure provides a method of eliminating ripples caused by LVDS spread spectrum, steps include obtaining a frame rate R, calculating a time t for displaying a frame of image according to the frame rate, according to the time t for displaying a frame of image, setting F_{MOD} to achieve t=k×(1/F_{MOD}), where F_{MOD} represents a frequency of spread spectrum modulating the LVDS signal, k is a positive integer, spread spectrum modulating the LVDS signal with F_{MOD} to generate and send a LVDS spread spectrum signal.

### BACKGROUND OF THE INVENTION

### 1. Field of the Disclosure

The disclosure relates to a liquid crystal display technical field, and more particularly to a method of eliminating ripples on a liquid crystal panel caused by low-voltage differential signaling (LVDS) spread spectrum.

### 2. Description of the Prior Art

A liquid crystal display (LCD) is the most widely applied flat display at present, which is becoming a display adopted by various electronic devices (i.e. a mobile phone, a personal digital assistant (PDA), a digital camera, a computer screen or a liquid crystal television).

Increasing electronic devices lead to electromagnetic interference (EMI). The electromagnetic interference can affect other electronic devices or human. Strict regulations on EMI have been given to the electronic devices. A conventional basic method to reduce EMI is to spread spectrum (SSC) modulate clocks or signals. For instance, aiming at a low-voltage differential signaling (LVDS) signal sending system, the LVDS signal is spread spectrum modulated.

However, spread spectrum modulating the LVDS signal can cause a problem of ripples on the liquid crystal display panel.

### SUMMARY OF THE DISCLOSURE

To solve the shortcoming in the prior art, exemplary embodiments of the disclosure provide a method of eliminating ripples on a liquid crystal panel caused by LVDS spread spectrum.

An exemplary embodiment of the disclosure provides a method of eliminating ripples caused by LVDS spread spectrum, steps include obtaining a frame rate R, calculating a time t for displaying a frame of image according to the frame rate, according to the time t for displaying a frame of image, setting F_{MOD} to achieve t=k×(1/F_{MOD}), where F_{MOD} represents a frequency of spread spectrum modulating the LVDS signal, k is a positive integer, spread spectrum modulating the LVDS signal with F_{MOD} to generate and send a LVDS spread spectrum signal.

Optionally, the time t for display a frame of image is t=1/R.

Optionally, steps of spread spectrum modulation are executed by a timer control register.

Optionally, frames of images are displayed on a liquid crystal panel.

According to the method of eliminating ripples caused by LVDS spread spectrum provided by exemplary embodiments of the disclosure, the problem of ripples on a liquid crystal panel caused by LVDS spread spectrum can be solved.

Other aspects and/or advantages of the disclosure will be partially illustrated as follows, another will be clear based on the description, or can be learnt from embodiments of the disclosure.

### BRIEF DESCRIPTION OF THE DRAWINGS

According to description of embodiments with figures, the previous-mentioned and/or other objectives and advantages of the disclosure will be clearer.

FIG. 1 is a simplified block diagram of a liquid crystal television according to an exemplary embodiment of the disclosure.

FIG. 2 is a low-voltage differential signaling spread spectrum (LVDS SCC) modulation waveform according to an exemplary embodiment of the disclosure.

FIG. 3 is a flow chart of a method of solving ripples caused by LVDS SCC according to an exemplary embodiment of the disclosure.

FIG. 4A and FIG. 4B are LVDS SCC modulation waveforms according to another exemplary embodiment of the disclosure.

### DETAILED DESCRIPTION OF PREFERRED EMBODIMENTS

Exemplary embodiments of the disclosure will be described, the exemplary embodiments will be illustrated in figures. A same label indicates a same section. The embodiments will be explained with reference to the accompanying drawings as follows for better understanding of the disclosure.

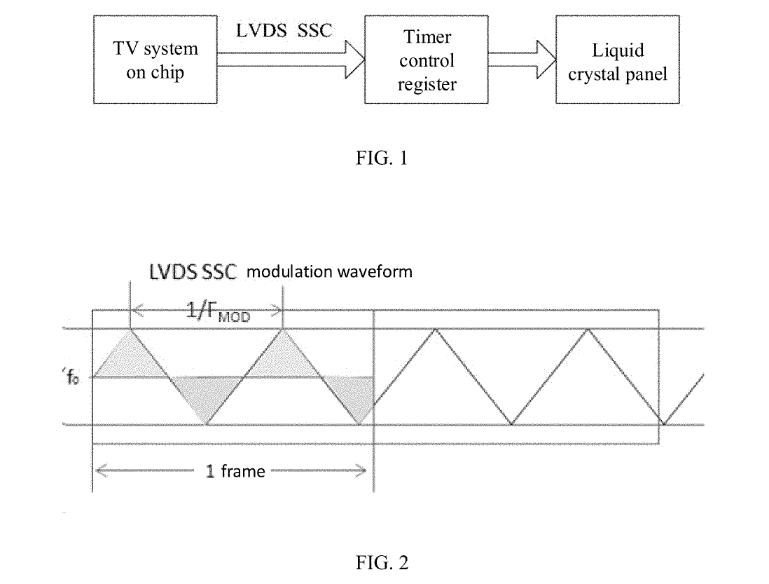

FIG. 1 is a simplified block diagram of a liquid crystal television according to an exemplary embodiment of the disclosure.

As shown in FIG. 1, the liquid crystal television can include a liquid crystal panel and a driving system of the liquid crystal panel. The driving system of the liquid crystal panel can include a TV system on chip (SOC) and a timer control register (TCON). The TV system on chip can output low-voltage differential signaling (LVDS) or a low-voltage differential signaling spread spectrum (LVDS SSC) signal, as well as setting up a spread spectrum modulation frequency F_{MOD} of the LVDS SSC signal, the LVDS SSC signal is a signal generated after spread spectrum of the LVDS signal, F_{MOD} indicates a frequency of the TCON spread spectrum modulating the LVDS signal. The TCON can generate a gating signal and control the liquid crystal panel to display frames of images.

FIG. 2 is a low-voltage differential signaling spread spectrum (LVDS SCC) modulation waveform according to an exemplary embodiment of the disclosure.

In FIG. 2, f₀ is a frequency of the LVDS signal without executing spread spectrum modulation, or a benchmark frequency.

In the LVDS SCC modulation waveform, during a period displaying each frame of image, when a sum of integral areas of positive bias compared with the benchmark frequency and a sum of integral areas of negative bias compared with the benchmark frequency are different, the gating signal generated by the TCON is triggered to vibrate so as to lead a liquid crystal panel to generate ripples.

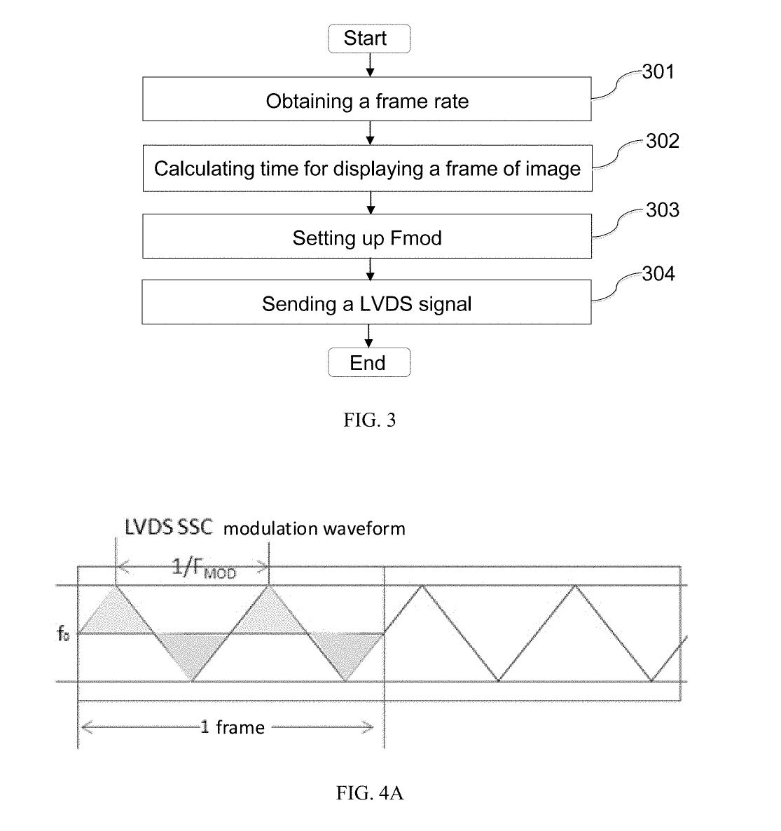

FIG. 3 is a flow chart of a method of eliminating ripples caused by LVDS spread spectrum according to an exemplary embodiment of the disclosure.

As shown in FIG. 3, in step 301, the TV system on chip obtains the frame rate R of a liquid crystal television, for instance, R=60 Hz.

In step 302, the TV system on chip calculates the time t for displaying a frame of image, t=1/R. For instance, when R=60 Hz, t=16.67 ms.

In step 303, according to the time t for displaying a frame of image, the TV system on chip sets up F_{MOD} to achieve t=k×(1/F_{MOD}), where k is an integer. For instance, when t=16.67 ms and k=1, F_{MOD} is set to be 1/16.67 ms.

In step 304, the LVDS signal is spread spectrum modulated by TCON according to F_{MOD} to generate and send the LVDS SSC signal.

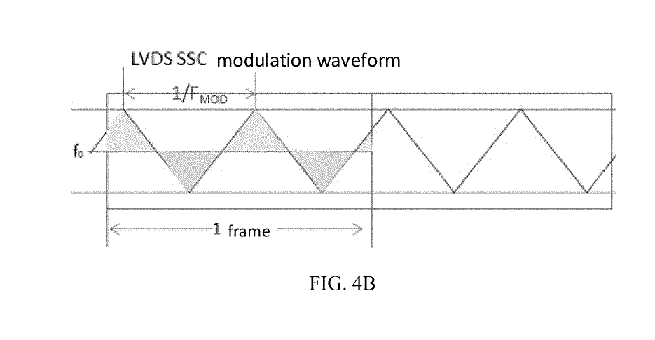

FIG. 4A and FIG. 4B are LVDS SCC modulation waveforms according to the exemplary embodiment of the disclosure.

As shown in FIG. 4A and FIG. 4B, in the LVDS SSC modulation waveforms, during the time t for display each frame of image, t=2×(1/F_{MOD}).

According to the method of eliminating ripples caused by LVDS spread spectrum of the exemplary embodiment of the disclosure, in the LVDS SSC modulation waveform, during a period displaying each frame of image, when a sum of integral areas of positive bias compared with the benchmark frequency and a sum of integral areas of negative bias compared with the benchmark frequency can be identical, so as to prevent the liquid crystal panel to generate ripples.

Furthermore, the method according to the disclosure can be coded in a computer readable medium. A person skilled in the art can achieve the code according to the description above. The method above can be achieved by running the code over a computer.

Moreover, each component in the driving device of the liquid crystal panel according to the exemplary embodiments of the disclosure can be hardware components. A person skilled in the art can adopt for example a field-programmable gate array (FPGA) or an application specific integrated circuit (ASIC) to be each component according to each restricted process executed by each component.

Above are merely exemplary embodiments of the disclosure, which do not limit the disclosure. It should be known by a person skilled in the art that any modifications, equivalent replacements or improvements within the spirit and principles of the disclosure can be achieved. The scope of the disclosure is limited in the claims and counterparts.

What is claimed is:

1. A method of eliminating ripples caused by LVDS spread spectrum, the method comprising:
obtaining a frame rate R;
calculating a time t for displaying a frame of image according to the frame rate;
according to the time t for displaying a frame of image, setting F_{MOD} to achieve t=k×(1/F_{MOD}), where F_{MOD} represents a frequency of spread spectrum modulating the LVDS signal, k is a positive integer;
spread spectrum modulating the LVDS signal with F_{MOD} to generate and send a LVDS spread spectrum signal.

2. The method according to claim 1, wherein the time for display a frame of image t is t=1/R.

3. The method according to claim 2, wherein steps of spread spectrum modulation are executed by a timer control register.

4. The method according to claim 1, wherein the frame of image is displayed on a liquid crystal panel.

5. A driving system of a liquid crystal panel, comprising: a timer control register, generating a gating signal and controlling frames of images displayed by a liquid crystal panel; and a TV system on chip, outputting LVDS or a LVDS spread spectrum signal, and setting F_{MOD} of the LVDS spread spectrum signal, where the LVDS spread spectrum signal is a signal generated after spread spectrum of the LVDS signal, F_{MOD} indicates a frequency of the timer control register spread spectrum modulating the LVDS signal,
according to a time t for displaying a frame of image, the TV system on chip setting F_{MOD} to achieve t=k×(1/F_{MOD}), where k is a positive integer.

6. The driving system according to claim 5, wherein the time for display a frame of image t is t=1/R, R is a frame rate.

7. The driving system according to claim 5, wherein the frame of image is displayed on the liquid crystal panel.
